(19) United States
(12) Patent Application Publication
(10) Pub. No.: US 2015/0217525 A1
(43) Pub. Date: Aug. 6, 2015

(54) RECYCLED RUBBER PARTICLES, PRODUCTS COMPRISING THE SAME, AND METHODS OF USING AND PRODUCING THE PRODUCTS

(71) Applicant: Dash Multi-Corp, Inc., Maryland Heights, MO (US)

(72) Inventors: Robert D. Cunningham, Maryland Heights, MO (US); Ahmed Zurkiya, Chattanooga, TN (US); Alexander Shashkov, Chattanooga, TN (US)

(73) Assignee: Dash Multi-Corp, Inc., Maryland Heights, MO (US)

(21) Appl. No.: 14/172,464

(22) Filed: Feb. 4, 2014

(51) Int. Cl. B29D 30/00; C08L 21/00; B29C 31/10; C08L 75/04

(52) U.S. Cl. CPC B29D 30/0061; C08L 75/04; C08L 21/00; B29C 31/10; B29K 2007/00

(57) ABSTRACT

The present disclosure provides recycled elastomeric particles, methods of preparing such elastomeric particles, elastomeric products containing such elastomeric particles, and methods and apparatuses for recycling used flat-proofed materials from industrial tires and producing flat-proofed tires using the recycled material.

### FIELD

The present disclosure generally relates to elastomeric particles, methods of preparing such compositions, and elastomeric products containing such particles. More particularly, the present disclosure relates to recycled/reclaimed rubber particles having certain size ratios. The present disclosure also relates to a method and apparatus for recycling reclaimed rubber particles producing flatproofed tires using the recycled material.

### BACKGROUND

This section provides background information related to the present disclosure.

Scrap rubber presents a serious waste product problem in the United States. A large percentage of scrap rubber is in the form of discarded tires with approximately over 250 million tires discarded annually. Recycling scrap rubber can be utilized to produce rubber products while simultaneously aiding the environmental problem created by scrap rubber.

Recycled rubber can be used for the manufacture of a wide variety of articles. Scrap rubber can be shredded into small particles, called rubber crumb, for use in rubber mats, road asphalt, and fashion accessories, among other uses.

D5603-01 (2008) “Standard Classification for Rubber Compounding Materials—Recycled Vulcanizate Particulate Rubber” describes various standard sizes used for recycled rubber crumb particles as shown in Table 1.

TABLE 1
Recycled Rubber Product Designation

| | | | | | Maximum |
|---|---|---|---|---|---|
| | | | | | Percent |
| | Example | | Percent | | Retained |
| Nominal | Classification | | Retained | | on |
| Product | D5603 | | on Zero | Size Designation | Designation |
| Designation | Designation\hat{ } | Zero Screen, μm | Screen | Screen, μm | Screen |
| 10 Mesh | Class 10-X | 2360 (8 Mesh) | 0 | 2000 (10 Mesh) | 5 |
| 20 Mesh | Class 20-X | 1180 (16 Mesh) | 0 | 850 (20 Mesh) | 5 |
| 30 Mesh | Class 30-X | 850 (20 Mesh) | 0 | 600 (30 Mesh) | 10 |
| 40 Mesh | Class 40-X | 600 (30 Mesh) | 0 | 425 (40 Mesh) | 10 |
| 50 Mesh | Class 50-X | 425 (40 Mesh) | 0 | 300 (50 Mesh) | 10 |
| 60 Mesh | Class 60-X | 300 (50 Mesh) | 0 | 250 (60 Mesh) | 10 |
| 70 Mesh | Class 70-X | 259 (60 Mesh) | 0 | 212 (70 Mesh) | 10 |
| 80 Mesh | Class 80-X | 250 (80 Mesh) | 0 | 180 (80 Mesh) | 10 |
| 100 Mesh | Class 100-X | 180 (80 Mesh) | 0 | 150 (100 Mesh) | 10 |
| 120 Mesh | Class 120-X | 180 (100 Mesh) | 0 | 128 (120 Mesh) | 15 |
| 140 Mesh | Class 140-X | 128 (120 Mesh) | 0 | 108 (140 Mesh) | 15 |
| 170 Mesh | Class 170-X | 106 (140 Mesh) | 0 | 90 (170 Mesh) | 15 |
| 200 Mesh | Class 200-X | 90 (170 Mesh) | 0 | 75 (200 Mesh) | 15 |

PCT Patent Publication WO 2011/113148 describes a method of regenerating rubber using a rubber crumb particle distribution of sizes ranging from 10 to 80 Mesh shown in Table 2.

TABLE 2
Particle Size Distribution for Untreated and Treated SBR Crumb

| | U-SBR | T-SBR |
|---|---|---|
| Mesh | (% weight) | (% weight) |
| 10 | 0.0 | 50.0 |
| 14 | 0.0 | 32.5 |
| 20 | 0.0 | 10.0 |
| 30 | 14.1 | 6.3 |
| 40 | 42.0 | 1.4 |
| 50 | 26.4 | 0.0 |
| 60 | 10.2 | 0.0 |
| 70 | 5.4 | 0.0 |
| 80 | 1.9 | 0.0 |

Conventional pneumatic vehicle tires consist of an outer casing which is given the desired load-bearing capacity and elasticity by air pumped into the casing (tubeless) or into an inner tube fitted within the casing (tubed). Unfortunately, such pneumatic tires are subject to explosive decompression when punctured. Therefore, there has long been needed an economical way for producing a tire that would eliminate losing the entire volume of compressed air from within a pneumatic tire when it is punctured.

Methods and apparatuses have been developed to produce a “flatproofed” tire. Liners of various types have been provided in the tire or between an inner tube and the tire casing serving to mitigate the effects of the tire casing being punctured. A more prevalent method for overcoming the problem is to convert pneumatic tires to solid or semi-solid composite tires. Such tires have gained a wide acceptance for certain mining, industrial, and construction uses where the added weight, and different dynamic performance characteristics could be tolerated for permanent protection from flat tires. Until recently, such solid deflation-proof tires have depended on a foamed or solid elastomer filling. A foamed filling in such tires has the advantage of lower material weight requirement to fill the tire, however these tires have disadvantages due to the insulating characteristics of the foam slowing the rate of heat transfer. For example, excessive heat can build-up within the tire and cause the filling to breakdown during service. Filling breakdown reduces the amount of support provided by the foamed elastomeric material potentially causing damage to usually expensive equipment. Solid elastomer fill materials for tires exhibit acceptable performance characteristics, however they are relatively more costly due to the higher fill weight required for a given tire size. Therefore, a change from merely using foam or elastomeric materials for a filling was required.

U.S. Pat. No. 6,918,979 to Shaffer describes methods for making tires filled with flatproofing material. The method for filling a tire cavity comprises: grinding cured polyurethane into core bits in a grinding device having an outlet; transferring ground core bits from the outlet to an adjacent elongated screw device; mixing core bits and a liquid virgin polyurethane in the elongated screw device; pressurizing and transferring the mixed material into the core of a tire; and electronically controlling the grinding device and the elongated screw device.

### SUMMARY

This section provides a general summary of the disclosure, and is not a comprehensive disclosure of its full scope or all of its features.

In an embodiment, the present disclosure provides recycled elastomeric particles of various sizes ranging 4 to 500 meshes, and compositions and articles comprising such particles.

In another embodiment, there is provided a method for filling a tire cavity, comprising providing a polyurethane elastomer and recycled rubber crumb particles, transferring the recycled rubber crumb particles from the outlet to an adjacent elongated screw device, mixing the recycled rubber crumb particles and the polyurethane elastomer in the elongated screw device, pressurizing and transferring the mixed material into the core of a tire, wherein the recycled rubber crumb particles are sized before incorporation into the liquid virgin polyurethane by a process of recycling used tires into a crumb form with a specific particle size distribution.

Further areas of applicability will become apparent from the description provided herein. This summary is intended for purposes of illustration only and is not intended to limit the scope of the present disclosure.

### BRIEF DESCRIPTION OF DRAWINGS

The figures described herein are for illustrative purposes only of selected embodiments and not all possible implementations, and are not intended to limit the scope of the present disclosure.

FIG. 1 is a schematic drawing of an apparatus or method to fill a tire cavity.

### DETAILED DESCRIPTION

The present disclosure provides recycled elastomeric particles, methods of preparing such recycled elastomeric particles, compositions and articles comprising recycled elastomeric particles of various sizes ratios, methods of preparing such compositions and articles, and methods for filling tire cavities with such recycled elastomeric particles.

The terms “rubber crumb” and “recycled elastomer” refer to any material derived by reducing scrap tires or other rubber into granules, and the terms are used interchangeably in this disclosure. Rubber crumb may be prepared by chopping, grinding, cutting or abrading scrap tires, scrap rubber, and similar elastomeric scrap streams into a particulate mixture. This process may be controlled using methods that are known in the art to achieve certain distributions of particle size as well as freedom from adulterants such as fiber, rocks, metal, and other debris through a variety of processes such as air separation, magnetic separation, and screening. Sources of scrap rubber include, but are not limited to, tires, gaskets, and molded goods. Scrap rubber may comprise various elastomeric materials including, but not limited to, natural rubber, butadiene rubber, chloroprene rubber, chlorosulfonylpolyethelene rubber, epichlorohydrin rubber, ethylene-propylene diene (EP DM) rubber, ethylene vinyl acetate rubber, halo-butyl rubber, isobutene-isoprene rubber, nitrile-butadiene rubber, polyisoprene rubber, styrene-butadiene (SBR) rubber, styrene-isoprene rubber, thermoplastic rubbers based on polyolefins, polyesters, styrene-butadiene polymers, polyurethanes, non-thermoplastic polyurethane rubbers, and plasticized polyvinyl chloride. In an embodiment, rubber crumb particles are polymerized rubbers from rubber monomers, particularly vulcanized rubbers. The recycled rubber particles of the present disclosure can be made of the same or different elastomeric materials.

Rubber crumb particles in accordance with the present disclosure may undergo processes to alter the properties of the particles. Such processes include, but are not limited to, treatment with coatings or lubricants, treatment with anti-caking additives, surface chemistry modification, vulcanization, devulcanization, and partial devulcanization.

Generally, a wide range of sizes of rubber crumb particles may be used for various processes and products using rubber crumb of the present disclosure. The particle sizes include standard sizes well recognized in the industry, such as the particle classifications of D5603-01 (2008) “Standard Classification for Rubber Compounding Materials—Recycled Vulcanizate Particulate Rubber.” Where necessary, particle size distribution is measured and characterized by passing the recycled crumb through a series of sieves. Specific particle sizes used in this disclosure, therefore, are sizes corresponding to the particle size either retained on the specified sieve size, or passing through the specified sieve size depending on the frame of reference.

Particles sizes can be described by the sieve size (e.g., 4 mesh, 6 mesh, etc.) as shown in Table 3. In some instances, specifications may be specific to the amount retained on a particular mesh size sieve and in some instances on the amount passing through a particular mesh size.

TABLE 3
Rubber Crumb Size Conversion Chart

| Diameter of Particle (mm) | Corresponding Mesh Size |
|---|---|
| 4.76 | 4 |
| 4.00 | 5 |
| 3.36 | 6 |
| 2.83 | 7 |
| 2.38 | 8 |
| 2.00 | 10 |
| 1.68 | 12 |
| 1.41 | 14 |
| 1.19 | 16 |
| 1.00 | 18 |
| 0.841 | 20 |
| 0.707 | 25 |
| 0.595 | 30 |
| . | . |
| . | . |
| . | . |
| 0.044 | 325 |
| 0.037 | 400 |

The particle sizes of rubber crumb of the present disclosure include particles corresponding to standard mesh opening ranging from 4 to 500 meshes. Also disclosed are various particle sizes smaller or bigger than standard mesh openings, e.g., various particle sizes between 4 mesh (4.75 mm) and 5 mesh (4.0 mm). In various embodiments, the rubber crumb particles have various maximum diameters, for example, 4.76 mm, 4.00 mm, 3.36 mm, 2.83 mm, 2.38 mm, 2.00 mm, 1.68 mm, 1.41 mm, 1.19 mm, 1.00 mm, 0.841 mm, 0.707 mm and 0.595 mm. Also included are particles sizes slightly bigger or smaller than standard sizes, such as, for example, 3.50 mm, 3.00 mm, 2.50 mm, 2.20 mm, 2.00 mm, 1.50 mm, 1.20 mm, 1.10 mm, 0.90 mm, 0.800 mm, 0.600 mm and 0.500 mm. A person having ordinary skill in the art can control the particle sizes as required for a final product.

In an embodiment, the rubber crumb particles in accordance with the present disclosure range in size from 30 to 6 mesh. In another embodiment, the rubber crumb particles have various size ranges, for example, 25 to 7 mesh, 20 to 7 mesh, 18 to 7 mesh, 16 to 7 mesh, 14 to 7 mesh, 12 to 7 mesh, 10 to 7 mesh, and 8 to 7 mesh. Also included are particle size ranges with maximum and minimum sizes slightly bigger or smaller than standard sizes.

In an embodiment, the rubber crumb particle size distribution in accordance with the present disclosure is 7 mesh sieve with a retained weight of 0%. In another embodiment, the rubber particle size distribution in accordance with the present disclosure is defined by consecutively putting the rubber crumb through a series of mesh sieves, such as, for example, a 7 and 8 mesh sieve for a retained weight up to 25%, a 7, 8, and 10 mesh sieve for a retained weight of 25 to 60%, a 7, 8, 10, and 14 mesh sieve for a retained weight of 60 to 100%, a 7, 8, 10, 14, and 18 mesh sieve for a retained weight of 70 to 100%, a 7, 8, 10, 14, 18 and 25 mesh sieve for a retained weight of 80 to 100%, and a 7, 8, 10, 14, 18, 25, and 30 mesh sieve for a retained weight of 90 to 100%.

In an embodiment, the rubber crumb particles in accordance with the present disclosure demonstrate a granulate size distribution as shown in Table 4.

TABLE 4
Ranged Size Distribution of Rubber Crumb Granulates

| | Min. Cumulative | Max. Cumulative |
|---|---|---|
| Rubber Crumb Size | Retained Weight % | Retained Weight % |
| 7 mesh | 0 | 0 |
| 7, 8, and 10 mesh | 20 | 80 |
| 7, 8, 10, 14, and 18 mesh | 80 | 100 |

In an embodiment, the rubber crumb particles demonstrate a granulate size distribution as shown in Table 5.

TABLE 5
Ranged Size Distribution of Rubber Crumb Granulates

| | Min. Cumulative | Max. Cumulative |
|---|---|---|
| Rubber Crumb Size | Retained Weight % | Retained Weight % |
| 7 mesh | 0 | 0 |
| 7, 8, and 10 mesh | 20 | 60 |
| 7, 8, 10, and 14 mesh | 60 | 100 |
| 7, 8, 10, 14, and 18 mesh | 80 | 100 |
| 7, 8, 10, 14, 18, and 25 mesh | 90 | 100 |

In an embodiment, the rubber crumb particles demonstrate a granulate size distribution as shown in Table 6.

TABLE 6
Ranged Size Distribution of Rubber Crumb Granulates

| | Min. Cumulative | Max. Cumulative |
|---|---|---|
| Rubber Crumb Size | Retained Weight % | Retained Weight % |
| 7 mesh | 0 | 0 |
| 7 and 8 mesh | 0 | 40 |
| 7, 8, and 10 mesh | 20 | 70 |
| 7, 8, 10, and 14 mesh | 60 | 100 |
| 7, 8, 10, 14, and 18 mesh | 80 | 100 |
| 7, 8, 10, 14, 18, and 25 mesh | 90 | 100 |

In an embodiment, the rubber crumb particles demonstrate a granulate size distribution as shown in Table 7.

TABLE 7
Ranged Size Distribution of Rubber Crumb Granulates

| | Min. Cumulative | Max. Cumulative |
|---|---|---|
| Rubber Crumb Size | Retained Weight % | Retained Weight % |
| 7 mesh | 0 | 0 |
| 7 and 8 mesh | 0 | 25 |
| 7, 8, and 10 mesh | 20 | 65 |
| 7, 8, 10, and 14 mesh | 60 | 100 |
| 7, 8, 10, 14, and 18 mesh | 85 | 100 |
| 7, 8, 10, 14, 18, and 25 mesh | 95 | 100 |

In an embodiment, the rubber crumb particles demonstrate a granulate size distribution as shown in Table 8.

TABLE 8
Size Distribution of Rubber Crumb Granulates

| | Min. Cumulative | Max. Cumulative |
|---|---|---|
| Rubber Crumb Size | Retained Weight % | Retained Weight % |
| 7 mesh | 0 | 0 |
| 7 and 8 mesh | 5 | 25 |
| 7, 8, and 10 mesh | 35 | 60 |
| 7, 8, 10, and 14 mesh | 70 | 90 |
| 7, 8, 10, 14, and 18 mesh | 95 | 100 |
| 7, 8, 10, 14, 18, and 25 mesh | 99.9 | 100 |

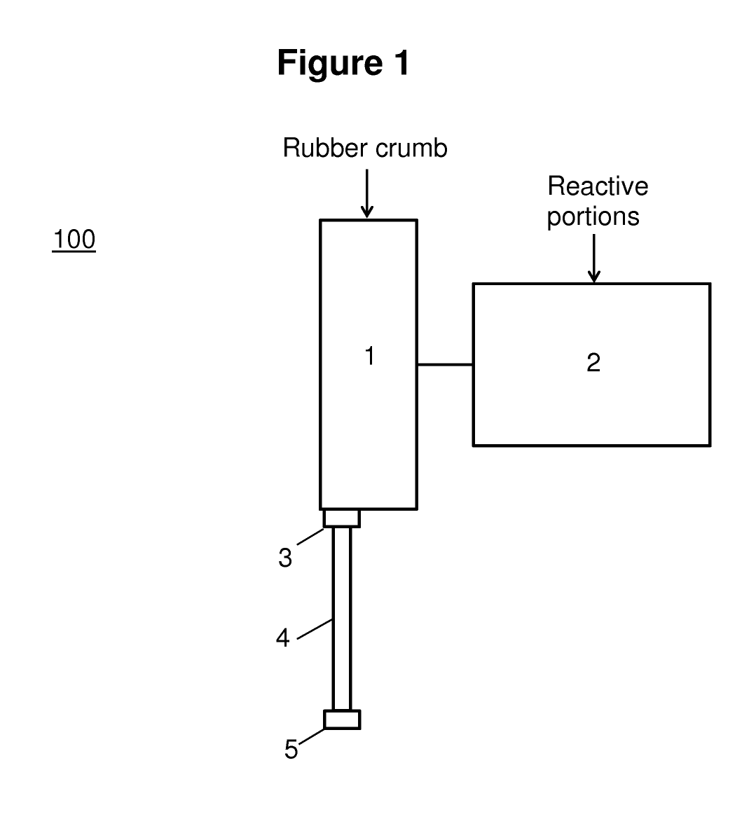

Referring to FIG. 1, an apparatus to fill a tire cavity is shown. The reactive mixer 2 includes a mixer that mixes at least two reactive portions to form a polyurethane elastomer such as, for example, a two component polyurethane elastomer. In an embodiment, the polyurethane elastomer is a two component virgin liquid polyurethane. The output of the reactive mixer 2 is fed into the injector/mixer 1 where the polyurethane elastomer is mixed with the ground rubber crumb. The output of the injector/mixer 1 is transferred to the adaptor 4 at transfer point 3. The adaptor 4 is an adaptor having an output 5 that can be attached to various sizes of tubed or tubeless pneumatic tires so that the pressurized mixture of the polyurethane elastomer and the rubber crumb can be introduced into the core of the tire to be filled.

During the process of pumping this mixture into a tire, the tire may need to be punctured to release the buildup of air pressure due to air compression by the input mixture. Thus, the inputting apparatus may be provided with a sensor that detects when the requisite OEM level is reached. This sensor then provides a signal to the user or automatically shuts down the filling of the tire. Any type of sensor known to those of ordinary skill suitable for detecting a specified pressure is used in the current invention.

After the tire is filled with the material mixture, it is set aside for a time period for the mixture to set-up or cure. Typically the time necessary for this curing is from about 24 to about 30 hours, which may be shorter than the curing time for other methods known in the art.

Thus, a tire produced using the above-described method and apparatus is filled with a mixture of the ground recycled rubber crumb and virgin flatproofing material. Further, the core of the tire of the present disclosure is generally filled with a sufficient amount of the described mixture so that approximately at least 99 percent of its volume is occupied by the mixture filled at a pressure sufficient to sustain design load and performance for the tire.

The mixture that fills the tubed or tubeless pneumatic tire generally comprises a mixture of from 10% to 70% recycled tire crumb with a polyurethane elastomer such as virgin polyurethane. In a particular embodiment, the mixture comprises at least 40 weight percent recycled tire crumb and 60 or less weight percent polyurethane elastomer. In other particular embodiments, the mixture is a mixture from about 10 or 70 percent ground material and the balance weight percent polyurethane elastomer.

While exemplary systems and methods embodying the present invention are shown by way of example, it will be understood, of course, that the invention is not limited to these embodiments. Modifications may be made by those skilled in the art, particularly in light of the foregoing teachings. For example, each of the features of the aforementioned embodiments and examples may be utilized in combination with other embodiments.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprise,” “comprising,” “contain,” “containing,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

What is claimed is:

1. A method for filling a tire cavity, comprising:
providing a polyurethane elastomer and recycled rubber particles, wherein the rubber particles are prepared in various specific particle size distributions;
mixing the polyurethane elastomer and the recycled rubber particles in the elongated screw device; and
pressurizing and transferring the mixed material into the core of a tire.

2. The method of claim 1, wherein the rubber particle size distribution is characterized by being put through a 7 mesh sieve for a cumulative retained weight of 0%.

3. The method of claim 1, wherein the rubber particle size distribution is characterized by being put through a 7 and 8 mesh sieve for a cumulative retained weight up to 25%.

4. The method of claim 1, wherein the rubber particle size distribution is characterized by being consecutively put through a 7, 8, and 10 mesh sieve for a cumulative retained weight of 25 to 60%.

5. The method of claim 1, wherein the rubber particle size distribution is characterized by being consecutively put through a 7, 8, 10, and 14 mesh sieve for a cumulative retained weight of 60 to 100%.

6. The method of claim 1, wherein the rubber particle size distribution is characterized by being consecutively put through a 7, 8, 10, 14, and 18 mesh sieve for a cumulative retained weight of 70 to 100%.

7. The method of claim 1, wherein the rubber particle size distribution is characterized by being consecutively put through a 7, 8, 10, 14, 18, and 25 mesh sieve for a cumulative retained weight of 80 to 100%.

8. The method of claim 1, wherein the rubber particle size distribution is characterized by being consecutively put through a 7, 8, 10, 14, 18, 25, and 30 mesh sieve for a cumulative retained weight of 90 to 100%.
